(19) United States
(12) Patent Application Publication
(10) Pub. No.: US 2026/0145792 A1
(43) Pub. Date: May 28, 2026

(54) SYSTEMS FOR PROVIDING A MOVING MAP OF FEATURES IN SPACE ON AN AIRCRAFT, AND ASSOCIATED DEVICES AND METHODS

(71) Applicant: Panasonic Avionics Corporation, Irvine, CA (US)

(72) Inventors: Andrew THOMPSON, Rancho Mission Viejo, CA (US); Philip WATSON, Lake Forest, CA (US); Sanjiv PIMPLE, Tustin, CA (US)

(21) Appl. No.: 18/959,345

(22) Filed: Nov. 25, 2024

(51) Int. Cl. B64D 11/00; G06F 3/01; G06V 20/59; G06V 40/10; G06V 40/20

(52) U.S. Cl. CPC B64D 11/0015; G06F 3/013; G06V 20/59; G06V 40/10; G06V 40/20

(57) ABSTRACT

Systems, devices, and methods for displaying celestial bodies in an aircraft are disclosed herein. In some embodiments, an IFEC system includes a database, a display device, and a processor operably coupled to the database and the display device. The processor can be configured to receive a first set of flight data from the aircraft, load a first GUI including one or more of the images and/or videos of celestial bodies arranged and/or modified based on the received first set of flight data, transmit the first GUI to the display device, receive a second set of flight data from the aircraft, load a second GUI based on the received second set of flight data, wherein the second GUI includes one or more of the images and/or videos of celestial bodies arranged and/or modified in a different manner than the first GUI, and transmit the second GUI to the display device.

### TECHNICAL FIELD

The present technology generally relates to systems for providing a moving map of features in space on an aircraft, and associated devices and methods.

### BACKGROUND

Air travel typically involves journeys over extended distances that at the very least take several hours to complete. Airlines thus often accommodate its customers with in-flight entertainment and communications (IFEC) systems that provide movies, TV shows, music, games, flight tracking, and other programs for passengers to interact with during the flight. However, frequent flyers, long distance travelers, and other passengers may become bored of existing programs and may want other forms of media in-flight. Accordingly, there is a need in the art for improved IFEC systems with a wider range of entertainment and information that can be provided to passengers.

### BRIEF DESCRIPTION OF THE DRAWINGS

Features, aspects, and advantages of the presently disclosed technology may be better understood with regard to the following drawings.

FIG. 1 is a partially schematic block diagram of an in-flight entertainment and communications (IFEC) system installed in an airplane and configured in accordance with embodiments of the present technology.

FIG. 2 is a schematic block diagram of a computing device configured in accordance with embodiments of the present technology.

FIG. 3 illustrates an IFEC system for a first class or business class seat and configured in accordance with embodiments of the present technology.

FIG. 4 illustrates an IFEC system for economy class seats and configured in accordance with embodiments of the present technology.

FIGS. 5A-5C illustrate example graphic user interfaces displayable on different screens or screen portions in accordance with embodiments of the present technology.

FIG. 6 illustrates an IFEC system configured to display a graphic user interface on a ceiling of an aircraft in accordance with embodiments of the present technology.

FIG. 7 is a flowchart illustrating a method for displaying celestial bodies on an aircraft in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present technology are directed to in-flight entertainment and communications (IFEC) systems that provide dynamic and varied views of celestial bodies and other outer space features to passengers on an aircraft in-flight. In-flight entertainment options have remained relatively unchanged over recent years. Although new music, TV shows, and movies are routinely made available in-flight, watching the same mode of entertainment can lead to a monotonous, repetitive, and unengaging experience for passengers, particularly during long flights and for frequent flyers.

Embodiments of the present technology address at least some of the above described issues for providing new forms of in-flight entertainment options. For example, embodiments of the present disclosure include an IFEC system for displaying celestial bodies in an aircraft. The IFEC system can include a database storing images and/or videos of celestial bodies, a display device, and a processor operably coupled to the database and the display device. The processor can be configured to (i) obtain a first set of flight data from the aircraft, (ii) generate, in a first time period, a first graphical user interface (GUI) including one or more of the images and/or videos of celestial bodies arranged and/or modified based on the obtained first set of flight data, the first time period, and a first position of a first display device of the display devices, (iii) transmit, in the first time period, the first GUI to the first display device, (iv) obtain a second set of flight data from the aircraft, (v) generate, in a second time period after the first time period, a second GUI based on the received second set of flight data, the second time period, and a second position of a second display device of the display devices, wherein the second GUI includes one or more of the images and/or videos of celestial bodies arranged and/or modified in a different manner than the first GUI based on the second, and (vi) transmit, in the second time period, the second GUI to the second display device.

Embodiments of the present disclosure can also include a method for displaying celestial bodies on an aircraft. The method can include (i) obtaining a first set of flight data from the aircraft, (ii) generating, in a first time period, a first GUI including one or more images and/or videos of celestial bodies arranged and/or modified based on the obtained first set of flight data, the first time period, and a first position of a first display device in the aircraft, (iii) transmitting, in the first time period, the first GUI to the first display device, (iv) obtaining a second set of flight data from the aircraft, (v) generating, in a second time period after the first time period, a second GUI based on the obtained second set of flight data, the second time period, and a second position of a second display device in the aircraft, wherein the second GUI includes one or more images and/or videos of celestial bodies arranged and/or modified in a different manner than the first GUI, and (vi) transmitting, in the second time period, the second GUI to the second display device.

Embodiments of the present technology provide significantly enhanced in-flight experiences for passengers. First, the IFEC systems can offer a dynamic view of celestial bodies and other outer space features, which can be displayed on various screens within the aircraft, including seatback display screens, personal electronic devices (PEDs), and even the ceiling of the airplane. This unique feature offers passengers an engaging and novel form of entertainment. Secondly, the IFEC systems ensure an accurate representation of celestial bodies by using flight data to generate GUIs that accurately correspond to the positions of the celestial bodies relative to the aircraft's current position and altitude, thereby providing a realistic and enhanced perception of outer space.

Additionally, the IFEC systems offer an interactive and personalized experience by allowing user inputs to select specific events such as particular celestial bodies, constellations, rocket launches, sunrises, sunsets, solar eclipses, lunar eclipses, and/or the like. The IFEC systems can also track eye and body movements of passengers to modify the GUI accordingly, making the experience more engaging. The versatility in display options is another advantage, as the system can project the dynamic view of celestial bodies on various devices and locations within the aircraft, providing flexibility in how passengers can view and interact with the content. Furthermore, the IFEC systems can provide real-time updates to the GUIs based on the aircraft's changing position and altitude, ensuring that the displayed celestial bodies and events are always current and spatially accurate. Lastly, by incorporating images and videos of celestial bodies and events, the IFEC systems can offer a wide range of content, catering to passengers who may seek alternatives to traditional in-flight entertainment options.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Select Embodiments of an IFEC System for Displaying Celestial Bodies on an Aircraft

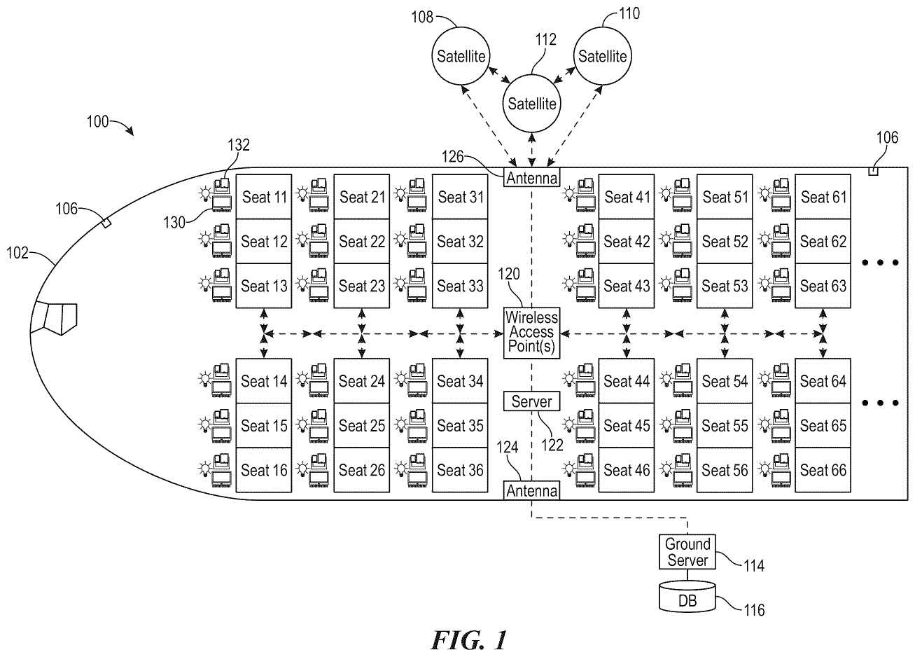

FIG. 1 is a partially schematic block diagram of an in-flight entertainment and communications (IFEC) system 100 installed in an airplane 102 and configured in accordance with embodiments of the present technology. The IFEC system 100 provides various entertainment and connectivity services to passengers on board via one or more IFEC devices 130 dedicated to each seat. In the illustrated implementation, the IFEC system 100 includes a wireless access point 120, a server 122, antenna 124, and antenna 126. The components shown as a single element in FIG. 1 (e.g., the server 122, the wireless access point 120, etc.) can be configured in multiple elements. For example, the IFEC system 100 can include multiple wireless access points 120 to facilitate or support providing wireless coverages for the passengers. The passengers can carry their own personal electronic devices (PEDs) 132 and/or other devices. The PEDs 132 may refer to any electronic computing device that includes one or more processors or circuitries for implementing the functions related to data storage, video and audio streaming, wired communications, wireless communications, etc. Examples of the PEDs 132 include cellular phones, smart phones, tablet computers, laptop computers, and other portable computing devices. In some implementations, the PEDs 132 may have the capability to execute application software programs (“apps”) to perform various functions. In some implementations, the PEDs 132 can be connected to the IFEC devices 130 to transfer data and/or power therebetween.

In FIG. 1, the airplane 102 is depicted to include multiple passenger seats, individually labeled Seat11 to Seat 66. The IFEC devices 130 are configured with capabilities for video and audio streaming, Internet communications, and other capabilities. In some implementations, the IFEC devices 130 are provided at each passenger seat, such as at each of the seatbacks of the passenger seats, on cabin walls, and/or deployable from an armrest for seats located at a bulkhead (i.e., in the first row of a section). The IFEC devices 130 can include displays providing interfaces to each passenger through which each passenger enters his or her selections on the entertainment option, e.g., the particular selections, emergency requests, etc. Upon receiving the selection from the passengers, based on the selections from the passengers, the IFEC devices 130 can display entertainment content and travel information.

The server 122 can be communicably coupled with the IFEC devices 130 and/or the PEDs 132 and perform various operations including processing requests/inputs from passengers and providing data to passengers. The communications between the server 122, the IFEC devices 130, and/or the PEDs 132 can be realized by wired and/or wireless connections. In some implementations, the communication between the server 122, the IFEC devices 130, and/or the PEDs 132 is achieved through the antenna 124 to and from a ground server 114 by, for example, a provision of network plugs at the seat for plugging the PEDs 132 to a wired onboard local area network. In some implementations, the communications between the server 122, the IFEC devices 130, and/or the PEDs 132 are achieved through the antenna 126 to and from satellites 108, 110, 112 in an orbit (e.g., via a cellular network utilizing one or more onboard base station(s), Wi-Fi utilizing the wireless access point 120, and/or Bluetooth).

In some implementations, a crew terminal is provided in the airplane 102 utilized by a ground crew, a cabin crew, or a flight crew to access the IFEC maintenance functions such as loading new content, replenishing multimedia content digital rights management (DRM) keys, and so on. The crew terminal can be in communication with other devices of the IFEC system 100 such as the server 122, the IFEC devices 130, the PEDs 132, and/or the ground server 114. In some implementations, the crew terminal can be implemented as a part of the server 122. In some implementations, the crew terminal can be used to control the content displayed on the displays of the IFEC devices 130.

The server 122, the IFEC devices 130, and the PEDs 132 can form a local network onboard the airplane 102 through an onboard router (not shown). The local network can communicate, via the antenna 124, with the ground server 114, which can be located at various locations, including a gate where passengers check-in the boarding pass right before passengers are on board, a computer center at an arbitrary location on the ground, etc. The ground server 114 may be in communication with a ground-based database 116 and provide information from the database 116 to the server 122 and store information received from the server 122 in the database 116. Although FIG. 1 shows that the database 116 is provided separately from the ground server 114, the database 116 can be provided as a part of the ground server 114.

As discussed further herein, the IFEC system 100 can be used to provide a dynamic view of celestial bodies and other features in outer space. The dynamic view can be displayed on the displays of the IFEC devices 130, the PEDs 132, a ceiling of the airplane 102, and/or elsewhere. For example, a processor of the server 122 can generate a graphical user interface (GUI) using images and/or videos of stars, planets, the night sky, and/or the like stored on a database of the server 122 and/or the ground-based database 116. The processor can also use images and/or videos captured by one or more cameras 106 positioned on the exterior of the airplane 102. In some implementations, the processor can receive and use flight data to generate the GUI such that the displayed arrangement of the celestial bodies accurately corresponds to a current position of the airplane 102. For example, a portion of a screen (e.g., of the IFEC devices 130 or the PEDs 132) can display only celestial bodies that are actually located in a direction behind the portion of the screen at any given time, providing passengers an accurate and enhanced perception of outer space in-flight.

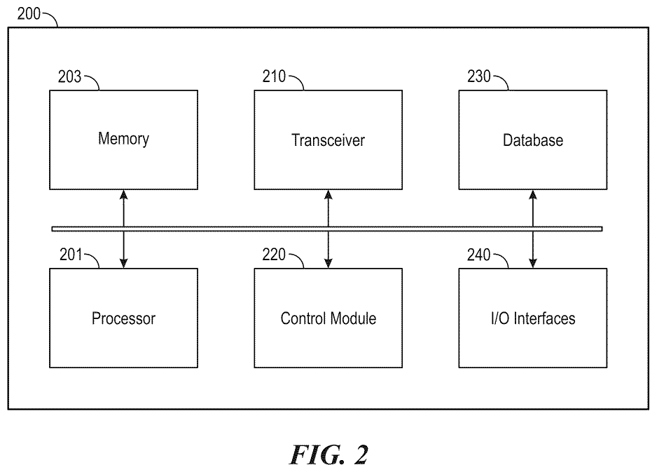

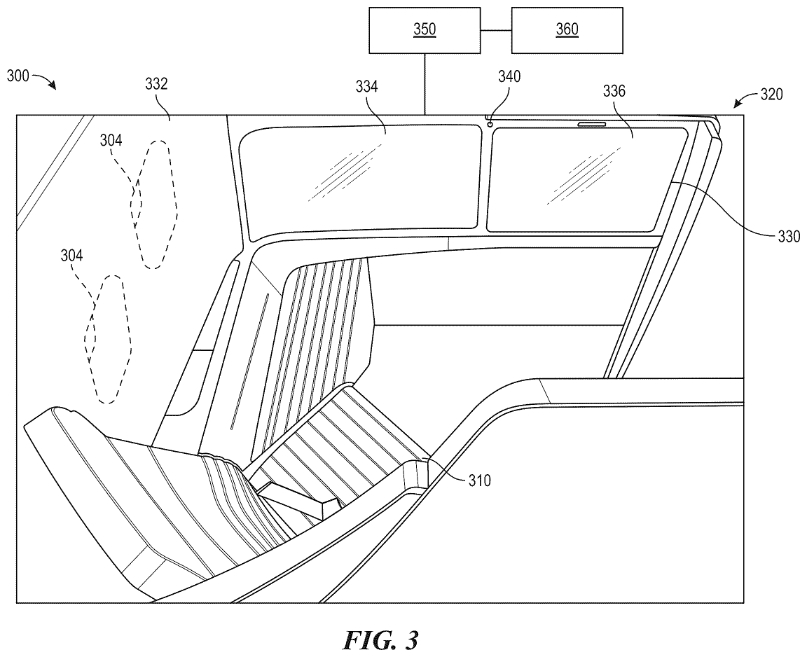

FIG. 2 is a schematic block diagram of a computing device 200 (e.g., an onboard server, a ground server, or a portable server) configured in accordance with embodiments of the present technology. The computing device 200 includes at least one processor 201, a memory 203, a transceiver 210, a control module 220, a database 230, and an input/output (I/O) interface 240. In other embodiments, additional, fewer, and/or different elements may be used to configure the computing device 200. The memory 203 may store instructions and applications to be executed by the processor 201. The memory 203 is an electronic holding place or storage for information or instructions so that the information or instructions can be accessed by the processor 201. The memory 203 can include, but is not limited to, any type of random access memory (RAM), any type of read-only memory (ROM), any type of flash memory, such as magnetic storage devices (e.g., hard disk, floppy disk, magnetic strips, etc.), optical disks (e.g., compact disc (CD), digital versatile discs (DVD), etc.), smart cards, flash memory devices, etc. The instructions upon execution by the processor 201 configure the computing device 200 to perform the operations (e.g., the operations as shown in and described with reference to FIGS. 3-7), which will be described in this patent document. The instructions executed by the processor 201 may be carried out by a special purpose computer, logic circuits, or hardware circuits. The processor 201 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 201 can perform the operations called for by that instruction.

The processor 201 (e.g., CPU(s), GPU(s), HPU(s), etc.) can be a single processing unit or multiple processing units in a device or distributed across multiple devices. The processor 201 can be operably coupled to the memory 203, the transceiver 210, the control module 220, the database 230, and the I/O interfaces 240 with the use of, for example, a bus, such as a PCI bus or SCSI bus to receive, send, and/or process information and to control the operations of the computing device 200. The processor 201 may retrieve a set of instructions from a permanent memory device, such as a ROM device, and copy the instructions in an executable form to a temporary memory device that is generally some form of RAM. In some implementations, the computing device 200 can include a plurality of processors that use the same or a different processing technology. The transceiver 210 may include a transmitter and a receiver. In some embodiments, the device 200 comprises a transmitter and a receiver that are separate from one another but functionally form a transceiver. The transceiver 210 can transmit or send information or data to another device (e.g., the IFE devices 130, a reader device, etc.) and receive information or data transmitted or sent by another device (e.g., another server, a PED, etc.).

The control module 220 of the computing device 200 can be configured to perform operations to assist the computing device 200. In some implementations, the control module 220 can be configured as a part of the processor 201. When the computing device 200 communicates with the IFEC devices 130 in FIG. 1, the control module 220 can be included in the airplane 102. In some implementations, the control module 220 can operate machine learning/artificial intelligence (AI) applications that perform various types of data analysis to automate analytical model building. Using algorithms that iteratively learn from data, machine learning applications can enable computers to learn without being explicitly programmed. The machine learning/AI module may be configured to use data learning algorithms to build models to interpret various data received from the various devices or components to detect, classify, and/or predict future outcomes. Such data learning algorithms may be associated with rule learning, artificial neural networks, inductive logic programming, and/or clustering. In some implementations, the control module 220 may assist the computing device 200 to perceive their environment and take actions that maximize the effectiveness of the operations performed by the computing device 200.

The database 230 can be configured to store various data accessible by the processor 201. For example, the database 230 can store image and videos (e.g., photographic, artistic renderings) of celestial bodies (e.g., stars, planets, asteroids, comets). It will be appreciated that while the description herein refers primarily to celestial bodies, other objects such as artificial satellites can be included in the scope of objects to be displayed in accordance with embodiments of the present technology. In another example, the database 230 can store preloaded graphical user interfaces (GUIs). In some implementations, the database 230 can be configured as part of the memory 203. In some implementations, a set of data stored on the database 230 can be swapped for a different set of data between flights depending on, e.g., the particular flight route, the departure time, the passengers onboard the airplane 102, and/or the like.

The I/O interfaces 240 can enable data to be provided to the computing device 200 as input and enable the computing device 200 to provide data as output. In some embodiments, the I/O interfaces 240 can receive flight data from another component of the airplane 102, such as an avionics system of the airplane 102. Flight data can include GPS data, altitude data, velocity data, weather data, flight route data, and/or the like. In some embodiments, the I/O interfaces 240 may enable user input to be obtained and received by the computing device 200 (e.g., via a touch-screen display, buttons, or switches) and may enable the computing device 200 to display information. In some embodiments, the IFEC devices 130, the PEDs 132, and/or other devices, including touch screen displays, buttons, controllers, audio speakers, or others, are connected to the computing device 200 via I/O interfaces 240.

In some implementations, the computing device 200 comprises a non-transitory computer-readable medium (e.g., the memory 203) including processor instructions that, when executed by one or more processors (e.g., the processor 201), cause the one or more processors to perform a method for displaying celestial bodies on an aircraft as described in further detail below with reference to FIGS. 3-7.

FIG. 3 illustrates an IFEC system 300 for a first class or business class seat 310 (“the seat 310”) and configured in accordance with embodiments of the present technology. The IFEC system 300 can include one or more IFEC devices 320 per seat 310, a processor 350 (shown schematically), and a database 360 (also shown schematically). The one or more IFEC devices 320 can include a display device 330 and an imaging device 340. The processor 350 can be operably coupled to the display device 330, the imaging device 340, the database 360, and other components in the aircraft, such as an avionics system, for receiving flight data therefrom. The processor 350 and/or the database 360 can be onboard the aircraft, ground-based, satellite-based, or elsewhere.

The display device 330 can include one or more LCD display screens, LED display screens, projected, holographic, or augmented reality displays (such as a heads-up display device or a head-mounted device), and/or the like. The display device 330 can include a touchscreen or a non-touchscreen. In the illustrated embodiment, the display device 330 includes a first display screen 332, a second display screen 334, and a third display screen 336. The first display screen 332 can extend along a sidewall of the aircraft. In particular, the first display screen 332 can extend over aircraft windows 304 and can have an adjustable transparency level to selectively display content or show the aircraft windows 304. The second display screen 334 and the third display screen 336 can extend substantially along a bulkhead or other partition. As shown, one or more of the display screens (e.g., the first display screen 332 and the second display screen 334) can be curved display screens. In other embodiments, all of the display screens can be flat display screens. Also, the first, second, and third display screens 332, 334, 336 can be separate display screens and/or portions of a single, larger screen.

The imaging device 340 (e.g., a camera) can be positioned to face the seat 310 and be configured to track eye movement and/or body movement of the passenger on the seat 310. The tracked eye movement and/or body movement can be communicated to a processor (not shown) of the IFEC system 300 as user input for controlling what is displayed on the display device 330. In some embodiments, in addition to or as an alternative to a touchscreen and/or the imaging device 340, the IFEC system 300 can further include a remote controller, a keyboard, a microphone, an audio jack, and/or other input device.

The database 360 can store media (e.g., images, videos, audio, text) associated with outer space and various celestial bodies. For example, the database 360 can store images of the night sky with stars visible, images of moons and planets (e.g., Saturn) at various zoom levels, videos of stars (e.g., Sirius), artistic renderings of galaxies (e.g., the Andromeda Galaxy), information (e.g., in text form) about constellations, and/or the like. The database 360 can also store preloaded graphical user interfaces (GUIs), such as an interactive map of the night sky with text-based overlays identifying the names (and other information) of select celestial bodies visible on the map.

In response to a user input, the processor 350 can load a GUI to be displayed on the display device 330 by accessing the media stored on the database 360. In some embodiments, the processor 350 loads GUIs suitable for display devices in first class or business class seats, which may have different curvatures, dimensions, and layouts compared to display devices in economy class seats. As discussed further herein, the GUI can include one or more of the images and/or videos of celestial bodies arranged and/or modified based on the flight data received.

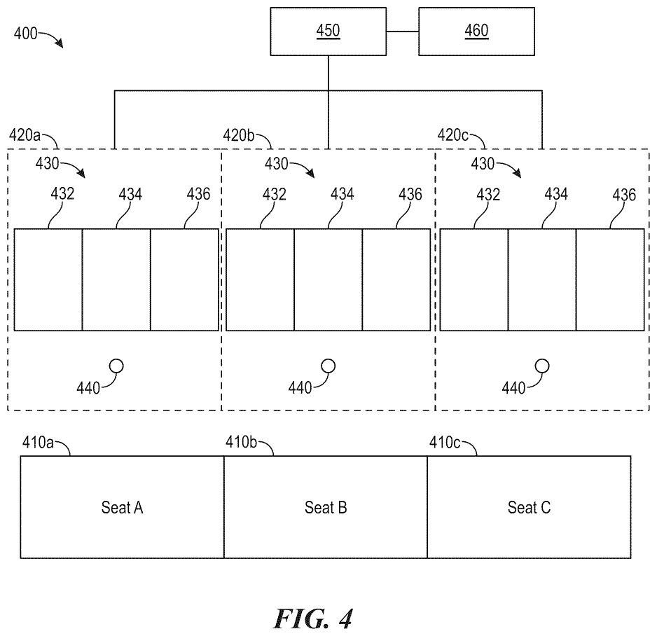

FIG. 4 illustrates an IFEC system 400 for economy class seats (individually labeled Seat A 410a, Seat B 410b, and Seat C 410c, and collectively referred to as “the seats 410”) and configured in accordance with embodiments of the present technology. The IFEC system 400 can include a first set of IFEC devices 420a dedicated for Seat A 410a, a second set of IFEC devices 420b dedicated for Seat B 410b, a third set of IFEC devices 420c dedicated for Seat C 410c (collectively referred to as “the sets of IFEC devices 420”), a processor 450, and a database 460. The processor 450 and/or the database 460 can be onboard the aircraft, ground-based, satellite-based, or elsewhere.

Each of the sets of IFEC devices 420 can include a display device 430 and an imaging device 440. The display device 430 and the imaging device 440 can be mounted on a seatback or a bulkhead in the aircraft. The display device 430 can include a first display screen 432, a second display screen 434, and a third display screen 436. The first, second, and third display screens 432, 434, 436 can be flat or curved screens. Also, the first, second, and third display screens 432, 434, 436 can be separate display screens and/or portions of a single, larger screen.

The processor 450 and the database 460 can be separate from or can form a single unit with the processor 350 and the database 360 of FIG. 3, respectively. The processor 450 and the database 460 can function similarly to the processor 350 and the database 360, respectively. for example, the database 460 can store media (e.g., images, videos, audio, text) associated with outer space and various celestial bodies, and the processor 450 can, in response to a user input, load a GUI to be displayed on the display device 430 by accessing the media stored on the database 460. In some embodiments, the processor 450 loads GUIs suitable for display devices in economy class seats, which may have different curvatures, dimensions, and layouts compared to display devices in first class or business class seats. As discussed further herein, the GUI can include one or more of the images and/or videos of celestial bodies arranged and/or modified based on the flight data received.

Referring to FIGS. 3 and 4 together, in operation, the processor (e.g., the processor 350, the processor 450) can load a GUI including one or more of the images, videos, or other forms of media of celestial bodies stored on the database (e.g., the database 360, the database 460) arranged and/or modified based on the flight data received. The GUI can be a combination of multiple images and/or videos of different celestial bodies arranged in a manner that accurately depicts the positions of the celestial bodies relative to the aircraft in real-time. For example, referring to the first class or business class seat 310 of FIG. 3, the first, second, and third display screens 332, 334, 336 can form a single, continuous GUI displaying outer space or the night sky, the first display screen 332 can display a first celestial body that is calculated to be in the direction of the first display screen 332 relative to the passenger (e.g., sideways from the aircraft), and the second display screen 334 can display a second celestial body that is calculated to be in the direction of the second display screen 334 relative to the passenger (e.g., forward of the aircraft). In some embodiments, the processor can load the GUI further based on the particular seat (e.g., the seat number, the position of the seat within the aircraft) associated with the device on which the GUI is to be displayed. The relative size, brightness, color, and/or other features of the first and second celestial bodies can be selected to provide a realistic perception that the passenger is looking out through a window into outer space from the aircraft. Therefore, the IFEC system can provide an outer space-based, immersive experience in an aircraft.

In some embodiments, the processor generates the GUI based on real-time flight data received from, e.g., an avionics system of the aircraft. Real-time flight data can include GPS data, altitude data, aircraft velocity data, and/or the like. For example, the processor can calculate, in real-time, the current positions of celestial bodies relative to the aircraft based on known orbit or other patterns of the celestial bodies and the current time, the GPS data of the aircraft (which can include the current position and orientation of the aircraft), and the altitude data of the aircraft. The processor can then determine the layout, size, color, and/or other features of the images and/or videos of the celestial bodies to be included in the GUI. In particular, the layout of the celestial bodies in the GUI (e.g., including a first celestial body at the bottom-left corner of a first display screen and including a second celestial body at the top-right corner of a second display screen) can be based on the calculated current positions of the celestial bodies relative to the aircraft. Subsequently, as the processor receives updated flight data, the processor can update the GUI to accurately reflect the updated flight data, such as by recalculating the current positions of the celestial bodies relative to the aircraft.

In some embodiments, the processor loads the GUI based on non-real-time flight data received from the aircraft. Non-real-time flight data can include a predetermined flight route of the aircraft, the departure time of the aircraft, and/or the like. For example, the database can store a plurality of GUIs including celestial bodies arranged in different layouts that accurately represent the predicted locations of the celestial bodies relative to the aircraft at various points in time along the flight route. The processor can retrieve select ones of the plurality of GUIs based on the current position of the aircraft along the predetermined flight route, and transmit the selected GUIs to the display device accordingly. Accordingly, the processor can transmit, to display devices, time-accurate GUIs illustrating celestial bodies without using real-time flight data, which can reduce the data transmission and processing load on the onboard server (e.g., the server 122 of FIG. 1).

In other embodiments, the processor can use a combination of both real-time and non-real-time flight data. For example, the database can store a plurality of GUIs paired with corresponding ones of a plurality of points or ranges along the flight route. The processor can determine the current position of the aircraft using real-time GPS data, and retrieve the appropriate GUI by using the pairs of GUIs and flight route segments as a lookup table. This can allow the processor to load more time-accurate GUIs without recalculating the real-time positions of celestial bodies relative to the aircraft in-flight. In some embodiments, the processor can dynamically vary the amount of real-time versus non-real-time flight data used depending on, e.g., the availability of processing power.

In some embodiments, the IFEC system can, in response to user inputs, provide various zoom levels of the celestial bodies displayed. For example, a passenger may touch the display device (e.g., a touchscreen) or use a remote to zoom-in from a solar system-level view to a planet-level view. Also, while FIGS. 3 and 4 illustrate three screens or screen portions per passengers seat, an IFEC system configured in accordance with embodiments of the present technology can include a different number, layout, etc. of screens. Additional examples of IFEC systems including multiple screens per passenger seat and curved display screens are described in further detail in U.S. patent application Ser. No. 18/638,610, titled “CURVED SEATBACK MONITORS AND ASSOCIATED SYSTEMS, DEVICES, AND METHODS,” and filed on Apr. 17, 2024, the disclosure of which is incorporated by reference herein in its entirety.

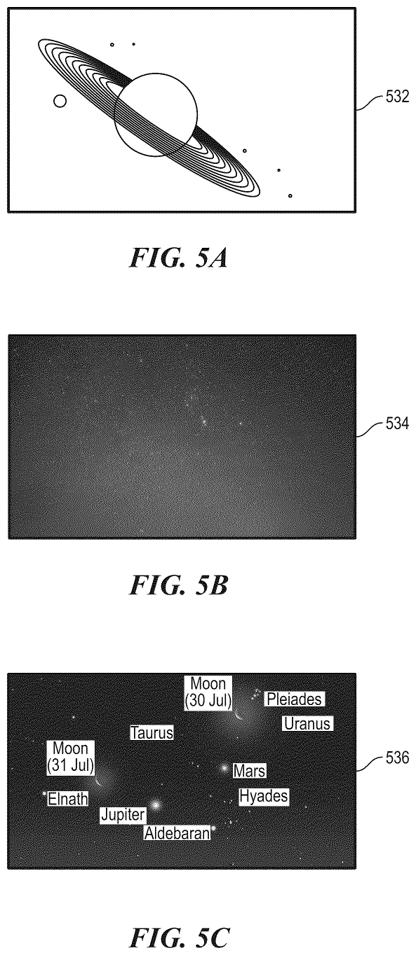

FIGS. 5A-5C illustrate example GUIs displayable on different screens or screen portions in accordance with embodiments of the present technology. Specifically, FIGS. 5A-5C illustrate a first display screen 532, a second display screen 534, and a third display screen 536, respectively, that can be examples of the first display screen 332, 432, the second display screen 334, 434, and the third display screen 336, 436, respectively. In the illustrated embodiment, the first display screen 532 (FIG. 5A) is displaying a view of celestial bodies selected by a user (e.g., Saturn and several of its moons). The first display screen 532 can display the selected celestial bodies at various zoom levels. The second display screen 534 (FIG. 5B) is displaying a view of the night sky with many stars visible within the frame. In some embodiments, the second display screen 534 can display images and/or videos captured by the cameras 106 (FIG. 1) on the exterior of the airplane 102. In some embodiments, the second display screen 534 can display images and/or videos captured by other imaging devices (e.g., on the ground), artistic renderings, and/or the like. The third display screen 536 (FIG. 5C) is displaying a view of the night sky with overlays (e.g., in text form) identifying the names of particular celestial bodies visible in the frame. In some embodiments, the third display screen 536 can serve as a selection screen that the passenger can use to select a particular celestial body, and the first display screen 532 can display an enlarged view of the selected celestial body.

Referring to FIGS. 5A-5C together, IFEC systems configured in accordance with embodiments of the present technology can simultaneously provide different content associated with celestial bodies and other features of outer space on different screens or screen portions to a single passenger in-flight. The various forms of content can provide entertainment and informational value to passengers.

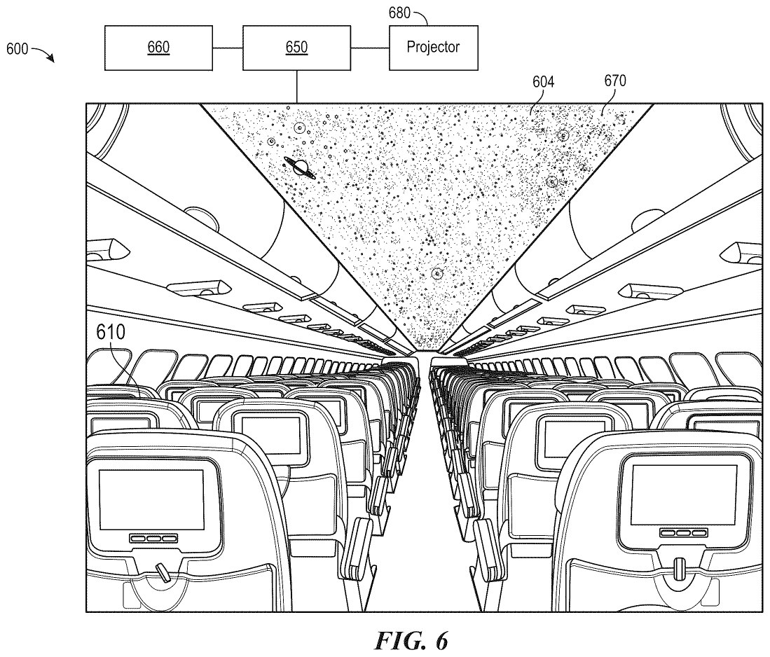

FIG. 6 illustrates an IFEC system 600 configured to display a GUI on a ceiling 604 of an aircraft in accordance with embodiments of the present technology. In particular, the IFEC system 600 can include a processor 650, a database 660, one or more display devices that can display the GUI on the ceiling 604. In some embodiments, the one or more display devices include a display screen 670 that extends across at least a portion of the ceiling 604. The processor 650 and/or the database 660 can be onboard the aircraft, ground-based, satellite-based, or elsewhere. In some embodiments, the one or more display devices include a projector 680 positioned to project images onto at least a portion of the ceiling 604. In some embodiments, the one or more display devices include one or more transparent display films (e.g., transparent LED films) installed on the ceiling 604 and/or other parts of the aircraft's interior. The display screen 670 and/or the projector 680 (and/or other display technologies) can display a GUI including enlarged views of one or more celestial bodies, the night sky, other features of outer space, and/or the like stored on the database 660. The GUI may or may not include overlays identifying select ones of the celestial bodies. Because the GUI is on the ceiling 604 of the aircraft, the GUI can be visible to passengers in all seats 610 and provide the perception that the passengers are in a spacecraft instead.

In some embodiments, the processor 650 can load GUIs that include multiple images and/or videos of different celestial bodies arranged in a manner that accurately depicts the positions of the celestial bodies relative to the aircraft in real-time, as discussed above with respect to the processors 350, 450. For example, the GUI displayed on the ceiling 604 can display celestial bodies that are positioned “above” the aircraft in real-time. This can provide additional entertainment and informational value to passengers who are using the display devices 330, 430 of FIGS. 3 and 4 because the ceiling 604 has a different orientation compared to the display devices 330, 430. Therefore, if the GUIs on the display devices 330, 430 and on the ceiling 604 are all configured to provide spatially accurate depictions of celestial bodies relative to the aircraft in real-time, the GUI on the ceiling 604 can depict celestial bodies that may not be displayed on the display devices 330, 430.

Referring to FIGS. 3-6 together, while the disclosure herein is primarily focused on displaying celestial bodies, embodiments of the present technology can be used to display other features or events that may have entertainment or informational value to passengers. For example, the processors can load GUIs that accurately depict the location of a rocket launch, a sunrise, a sunset, a solar eclipse, a lunar eclipse, a constellation, and/or the like relative to the aircraft in real-time. Also, while the disclosure herein is primarily focused on displaying GUIs on display devices included in the aircraft, the GUIs can be transmitted to and displayed on personal electronic devices (e.g., the PEDs 132 of FIG. 1), presented to the user in audio form, etc.

### III. Select Embodiments of a Method for Displaying Celestial Bodies on an Aircraft

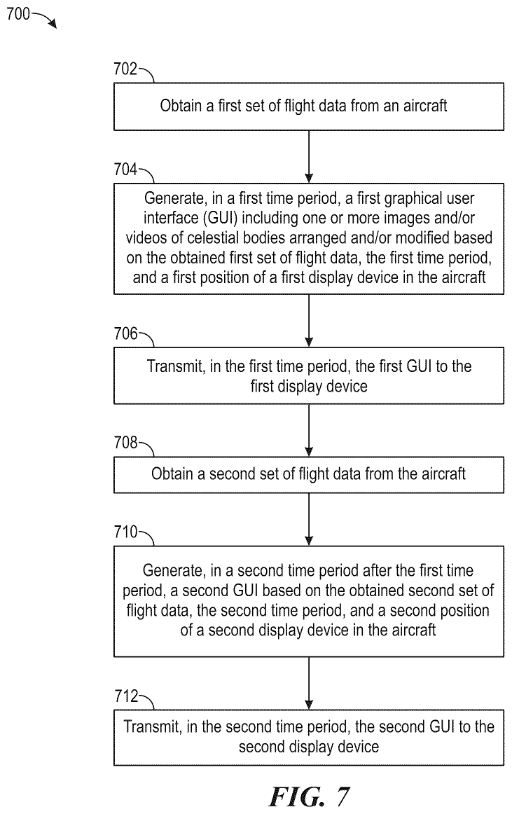

FIG. 7 is a flowchart illustrating a method for displaying celestial bodies on an aircraft in accordance with embodiments of the present technology. While the steps of the method 700 are described below in a particular order, one or more of the steps can be performed in a different order or omitted, and the method 700 can include additional and/or alternative steps. Additionally, although the method 700 may be described below with reference to the embodiments of the present technology described herein, the method 700 can be performed with other embodiments of the present technology.

The method 700 begins at block 702 by obtaining a first set of flight data from the aircraft. The first set of flight data can include real-time and/or non-real-time flight data. The first set of flight data can include a current position and a current altitude of the aircraft at a first point in time. The first set of flight data can include a first portion of a flight route. In some embodiments, the first set of flight data is received from a database onboard the aircraft. Obtaining the first set of flight data can comprise reading preloaded information (e.g., on a database), taking a snapshot of real-time information when the first set of flight data is requested or needed, and/or the like.

At block 704, the method 700 continues by generating, in a first time period, a GUI including one or more images and/or videos of celestial bodies arranged and/or modified based on the obtained first set of flight data, the first time period, and a first position of a first display device in the aircraft. Generating the first GUI can include (i) arranging and/or modifying the one or more images and/or videos of celestial bodies to correspond to a perspective of the celestial bodies from the current position and the current altitude of the aircraft, (ii) retrieving the first GUI from a database onboard the aircraft, and/or (iii) generating the first GUI based on the images and/or videos of celestial bodies stored on a database onboard the aircraft.

At block 706, the method 700 continues by transmitting, in the first time period, the first GUI to the first display device. The display device can include display screens on a seatback or bulkhead, display screens on a ceiling of the aircraft, a projector configured to project images onto the ceiling, and/or the like. In some embodiments, the first GUI is generated in a manner suitable for display on the particular display device, such as by taking into account the number, dimensions, layout, etc. of the screens for a given passenger seat. The first time period can be no more than 10 seconds, 5 seconds, 3 seconds, 1 second, or 0.5 seconds such that the first GUI is both generated and transmitted within a relatively short time period.

At block 708, the method 700 continues by obtaining a second set of flight data from the aircraft. The second set of flight data can include real-time and/or non-real-time flight data. The second set of flight data can include a current position and a current altitude of the aircraft at a second point in time. The second set of flight data can include a second portion of a flight route. In some embodiments, the second set of flight data is received from a database onboard the aircraft. The second set of flight data can be received after receiving the first set of flight data. Obtaining the second set of flight data can comprise reading preloaded information (e.g., on a database), taking a snapshot of real-time information when the second set of flight data is requested or needed, and/or the like.

At block 710, the method 700 continues by generating, in a second time period after the first time period, a second GUI based on the obtained second set of flight data, the second time period, and a second position of a second display device in the aircraft. The second GUI can include one or more images and/or videos of celestial bodies arranged and/or modified in a different manner than the first GUI. Loading the second GUI can include (i) updating the first GUI to correspond to a perspective of the celestial bodies from the position of the aircraft at the second time, (ii) retrieving the second GUI from the database, and/or (iii) generating the second GUI based on the images and/or videos of celestial bodies stored on the database. The second display device can be the same as the first display device, or different from the first display device. In some embodiments, the second time period corresponds to a subsequent or separate instance in which a passenger requests stargazing media on the aircraft after the first time period. Therefore, even if the first display device and the second display device are the same, the first position of the first display device can be different from the second position of the second display device. For example, the second position can be several miles ahead of the first position (e.g., the distance the aircraft traveled between the first time period and the second time period), and the orientation of the aircraft can also be different (e.g., the aircraft may have turned between the first time period and the second time period).

At block 712, the method 700 continues by transmitting, in the second time period, the second GUI to the second display device. As discussed above, the display device can include display screens on a seatback or bulkhead, display screens on a ceiling of the aircraft, a projector configured to project images onto the ceiling, and/or the like. In some embodiments, the second GUI is loaded in a manner suitable for display on the particular display device, such as by taking into account the number, dimensions, layout, etc. of the screens for a given passenger seat. The second time period can be no more than 10 seconds, 5 seconds, 3 seconds, 1 second, or 0.5 seconds such that the second GUI is both generated and transmitted within a relatively short time period.

In some embodiments, the method 700 further includes receiving a user input selecting an event (e.g., a rocket launch, a sunrise, a sunset, a solar eclipse, a lunar eclipse), generating, in a third time period after the second time period, a third GUI, and transmitting the third GUI to a third display device in the aircraft. The third GUI can include one or more images and/or videos of the selected event. Loading the third GUI can include at least one of arranging or modifying the one or more images and/or videos of the selected event to correspond to a perspective of the selected event from the current position and the current altitude of the aircraft.

In some embodiments, the method 700 further includes receiving tracked eye and/or body movement of a passenger from an imaging device (e.g., a camera) onboard the aircraft, generating, in a third time period after the second time period, a third GUI based on the received tracked eye and/or body movement, the third time period, and a third position of a third display device in the aircraft, and transmitting, in the third time period, the third GUI to the display device. The third GUI can include one or more images and/or videos of celestial bodies arranged and/or modified in a different manner than the first GUI and the second GUI.

IFEC systems configured in accordance with embodiments of the present technology provide significantly enhanced in-flight experiences for passengers. First, the IFEC systems can offer a dynamic view of celestial bodies and other outer space features, which can be displayed on various screens within the aircraft, including seatback display screens, personal electronic devices (PEDs), and even the ceiling of the airplane. This unique feature offers passengers an engaging and novel form of entertainment. Secondly, the IFEC systems ensure an accurate representation of celestial bodies by using flight data to generate GUIs that accurately correspond to the positions of the celestial bodies relative to the aircraft's current position and altitude, thereby providing a realistic and enhanced perception of outer space.

Additionally, the IFEC systems offer an interactive and personalized experience by allowing user inputs to select specific events such as particular celestial bodies, constellations, rocket launches, sunrises, sunsets, solar eclipses, lunar eclipses, and/or the like. The IFEC systems can also track eye and body movements of passengers to modify the GUI accordingly, making the experience more engaging. The versatility in display options is another advantage, as the system can project the dynamic view of celestial bodies on various devices and locations within the aircraft, providing flexibility in how passengers can view and interact with the content. Furthermore, the IFEC systems can provide real-time updates to the GUIs based on the aircraft's changing position and altitude, ensuring that the displayed celestial bodies and events are always current and spatially accurate. Lastly, by incorporating images and videos of celestial bodies and events, the IFEC systems can offer a wide range of content, catering to passengers who may seek alternatives to traditional in-flight entertainment options.

### IV. Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner. In these examples, the term “a processor” is used to indicate a group of one or more processors that may be configured to implement different operations that are performed by the examples. For example, in example 1, one processor may be configured to implement the receive operation, while another processor may be configured to implement the load operations and yet another processor may perform the transmit operations.
1. An in-flight entertainment and communications (IFEC) system for displaying celestial bodies in an aircraft, the IFEC system comprising:
a database storing images and/or videos of celestial bodies;
display devices in the aircraft; and
a processor operably coupled to the database and the display devices, wherein the processor is configured to:
   obtain a first set of flight data from the aircraft,
   generate, in a first time period, a first graphical user interface (GUI) including one or more of the images and/or videos of celestial bodies arranged and/or modified based on the obtained first set of flight data, the first time period, and a first position of a first display device of the display devices,
   transmit, in the first time period, the first GUI to the first display device,
   obtain a second set of flight data from the aircraft,
   generate, in a second time period after the first time period, a second GUI based on the obtained second set of flight data, the second time period, and a second position of a second display device of the display devices, wherein the second GUI includes one or more of the images and/or videos of celestial bodies arranged and/or modified in a different manner than the first GUI, and
   transmit, in the second time period, the second GUI to second display device.
2. The IFEC system of example 1, wherein at least one of the first or second display device comprises either a projector configured to project the first GUI and the second GUI onto a ceiling of the aircraft or a screen on the ceiling of the aircraft.
3. The IFEC system of example 1 or example 2, wherein the processor is configured to generate the first GUI further based on a cabin class associated with at least one of the first or second display device.
4. The IFEC system of any of examples 1-3, wherein at least one of the first or second display device includes a first screen portion, a second screen portion, and a third screen portion.
5. The IFEC system of example 4, wherein the first GUI includes:
a first GUI portion including an enlarged image or video of a celestial body and displayable on the first screen portion;
a second GUI portion including a view of the sky from the aircraft and displayable on the second screen portion; and
a third GUI portion including a plurality of the celestial bodies and one or more overlays identifying one or more of the plurality of celestial bodies, and displayable on the third screen portion.
6. The IFEC system of any of examples 1-5, wherein the first set of flight data includes an indication that the aircraft is at a first position along a flight route, and wherein the second set of flight data includes an indication that the aircraft is at a second position along the flight route and different from the first position.
7. The IFEC system of any of examples 1-6, wherein the processor is configured to generate the first GUI by retrieving the first GUI from the database, and wherein the processor is configured to generate the second GUI by retrieving the second GUI from the database.
8. The IFEC system of any of examples 1-7, wherein the processor is configured to generate each of the first GUI and the second GUI based on the images and/or videos of celestial bodies stored on the database.
9. The IFEC system of any of examples 1-8, further comprising a camera configured to track eye movement of a passenger, wherein the processor is further configured to:
receive the tracked eye movement from the camera;
generate, in a third time period after the second time period, a third GUI based on the received tracked eye movement, the third time period, and a third position of a third display device of the display devices, wherein the third GUI includes one or more of the images and/or videos of celestial bodies arranged and/or modified in a different manner than the first GUI and the second GUI; and
transmit, in the third time period, the third GUI to the third display device.
10. The IFEC system of any of examples 1-9, further comprising a camera configured to track body movement of a passenger, wherein the processor is further configured to:
receive the tracked body movement from the camera;
generate, in a third time period after the second time period, a third GUI based on the received
tracked body movement, the third time period, and a third position of a third display device of the display devices, wherein the third GUI includes one or more of the images and/or videos of celestial bodies arranged and/or modified in a different manner than the first GUI and the second GUI; and

transmit, in the third time period, the third GUI to the third display device.
11. The IFEC system of any of examples 1-10, wherein the first set of flight data includes at least two of GPS data, altitude data, or flight route.
12. A method for displaying celestial bodies on an aircraft, the method comprising:
obtaining a first set of flight data from the aircraft;
generating, in a first time period, a first graphical user interface (GUI) including one or more images and/or videos of celestial bodies arranged and/or modified based on the
obtained first set of flight data, the first time period, and a first position of a first display device in the aircraft;
transmitting, in the first time period, the first GUI to the first display device;
obtaining a second set of flight data from the aircraft;
generating, in a second time period after the first time period, a second GUI based on the obtained second set of flight data, the second time period, and a second position of a second display device in the aircraft, wherein the second GUI includes one or more images and/or videos of celestial bodies arranged and/or modified in a different manner than the first GUI; and
transmitting, in the second time period, the second GUI to the second display device.
13. The method of example 12, wherein the first set of flight data includes a current position and a current altitude of the aircraft, and wherein generating the first GUI comprises at least one of arranging or modifying the one or more images and/or videos of celestial bodies to correspond to a perspective of the celestial bodies from the current position and the current altitude of the aircraft.
14. The method of example 12 or example 13, wherein the first set of flight data includes a first position of the aircraft at a first time, wherein the second set of flight data includes a second position of the aircraft at a second time after the first time, and wherein generating the second GUI comprises updating the first GUI to correspond to a perspective of the celestial bodies from the second position of the aircraft at the second time.
15. The method of any of examples 12-14, wherein generating the first GUI comprises retrieving the first GUI from a database onboard the aircraft, and wherein generating the second GUI comprises retrieving the second GUI from the database.
16. The method of any of examples 12-15, wherein generating the first GUI comprises generating the first GUI based on the images and/or videos of celestial bodies stored on a database onboard the aircraft, and wherein generating the second GUI comprises generating the second GUI based on the images and/or videos of celestial bodies stored on the database.
17. The method of any of examples 12-16, further comprising:
receiving a user input selecting an event from the group including a rocket launch, a sunrise, a sunset, a solar eclipse, or a lunar eclipse;
generating, in a third time period after the second time period, a third GUI including one or more images and/or videos of the selected event; and
transmitting, in the third time period, the third GUI to a third display device in the aircraft.
18. The method of any of examples 12-17, further comprising:
receiving tracked eye movement of a passenger from a camera onboard the aircraft;
generating, in a third time period after the second time period, a third GUI based on the received tracked eye movement, the third time period, and a third position of a third display device in the aircraft, wherein the third GUI includes one or more images
and/or videos of celestial bodies arranged and/or modified in a different manner than the first GUI and the second GUI; and
transmitting, in the third time period, the third GUI to the third display device.
19. The method of any of examples 12-18, further comprising:
receiving tracked body movement of a passenger from a camera onboard the aircraft;
generating, in a third time period after the second time period, a third GUI based on the received tracked body movement, the third time period, and a third position of a third display device in the aircraft, wherein the third GUI includes one or more images and/or videos of celestial bodies arranged and/or modified in a different manner than the first GUI and the second GUI; and
transmitting, in the third time period, the third GUI to the third display device.
20. A non-transitory computer-readable medium onboard an aircraft and having instructions configured to cause one or more processors to perform a method, the method comprising:
obtaining a first set of flight data from the aircraft;
generating, in a first time period, a first graphical user interface (GUI) including one or more images and/or videos of celestial bodies arranged and/or modified based on the obtained first set of flight data, the first time period, and a first position of a first display device in the aircraft;
transmitting, in the first time period, the first GUI to the first display device;
obtaining a second set of flight data from the aircraft;
generating, in a second time period after the first time period, a second GUI based on the obtained second set of flight data, the second time period, and a second position of a second display device in the aircraft, wherein the second GUI includes one or more images and/or videos of celestial bodies arranged and/or modified in a different manner than the first GUI; and
transmitting, in the second time period, the second GUI to the second display device.

### V. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

To the extent any material incorporated herein by reference conflicts with the present disclosure, the present disclosure controls. Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values used in the specification and claims, are to be understood as being modified in all instances by the term “about.” Accordingly, unless indicated to the contrary, the numerical parameters set forth in the specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. An in-flight entertainment and communications (IFEC) system for displaying celestial bodies in an aircraft, the IFEC system comprising:
a database storing images and/or videos of celestial bodies;
display devices in the aircraft; and
a processor operably coupled to the database and the display devices, wherein the processor is configured to:
obtain a first set of flight data from the aircraft,
generate, in a first time period, a first graphical user interface (GUI) including one or more of the images and/or videos of celestial bodies arranged and/or modified based on the obtained first set of flight data, the first time period, and a first position of a first display device of the display devices,
transmit, in the first time period, the first GUI to the first display device,
obtain a second set of flight data from the aircraft,
generate, in a second time period after the first time period, a second GUI based on the obtained second set of flight data, the second time period, and a second position of a second display device of the display devices, wherein the second GUI includes one or more of the images and/or videos of celestial bodies arranged and/or modified in a different manner than the first GUI, and
transmit, in the second time period, the second GUI to second display device.

2. The IFEC system of claim 1, wherein at least one of the first or second display device comprises either a projector configured to project the first GUI and the second GUI onto a ceiling of the aircraft or a screen on the ceiling of the aircraft.

3. The IFEC system of claim 1, wherein the processor is configured to generate the first GUI further based on a cabin class associated with at least one of the first or second display device.

4. The IFEC system of claim 1, wherein at least one of the first or second display device includes a first screen portion, a second screen portion, and a third screen portion.

5. The IFEC system of claim 4, wherein the first GUI includes:
a first GUI portion including an enlarged image or video of a celestial body and displayable on the first screen portion;
a second GUI portion including a view of the sky from the aircraft and displayable on the second screen portion; and
a third GUI portion including a plurality of the celestial bodies and one or more overlays identifying one or more of the plurality of celestial bodies, and displayable on the third screen portion.

6. The IFEC system of claim 1, wherein the first set of flight data includes an indication that the aircraft is at a first position along a flight route, and wherein the second set of flight data includes an indication that the aircraft is at a second position along the flight route and different from the first position.

7. The IFEC system of claim 1, wherein the processor is configured to generate the first GUI by retrieving the first GUI from the database, and wherein the processor is configured to generate the second GUI by retrieving the second GUI from the database.

8. The IFEC system of claim 1, wherein the processor is configured to generate each of the first GUI and the second GUI based on the images and/or videos of celestial bodies stored on the database.

9. The IFEC system of claim 1, further comprising a camera configured to track eye movement of a passenger, wherein the processor is further configured to:
receive the tracked eye movement from the camera;
generate, in a third time period after the second time period, a third GUI based on the received tracked eye movement, the third time period, and a third position of a third display device of the display devices, wherein the third GUI includes one or more of the images and/or videos of celestial bodies arranged and/or modified in a different manner than the first GUI and the second GUI; and
transmit, in the third time period, the third GUI to the third display device.

10. The IFEC system of claim 1, further comprising a camera configured to track body movement of a passenger, wherein the processor is further configured to:
receive the tracked body movement from the camera;
generate, in a third time period after the second time period, a third GUI based on the received tracked body movement, the third time period, and a third position of a third display device of the display devices, wherein the third GUI includes one or more of the
images and/or videos of celestial bodies arranged and/or modified in a different manner than the first GUI and the second GUI; and
transmit, in the third time period, the third GUI to the third display device.

11. The IFEC system of claim 1, wherein the first set of flight data includes at least two of GPS data, altitude data, or flight route.

12. A method for displaying celestial bodies on an aircraft, the method comprising:
obtaining a first set of flight data from the aircraft;
generating, in a first time period, a first graphical user interface (GUI) including one or more images and/or videos of celestial bodies arranged and/or modified based on the obtained first set of flight data, the first time period, and a first position of a first display device in the aircraft;
transmitting, in the first time period, the first GUI to the first display device;
obtaining a second set of flight data from the aircraft;
generating, in a second time period after the first time period, a second GUI based on the obtained second set of flight data, the second time period, and a second position of a second display device in the aircraft, wherein the second GUI includes one or more images and/or videos of celestial bodies arranged and/or modified in a different manner than the first GUI; and
transmitting, in the second time period, the second GUI to the second display device.

13. The method of claim 12, wherein the first set of flight data includes a current position and a current altitude of the aircraft, and wherein generating the first GUI comprises at least one of arranging or modifying the one or more images and/or videos of celestial bodies to correspond to a perspective of the celestial bodies from the current position and the current altitude of the aircraft.

14. The method of claim 12, wherein the first set of flight data includes a first position of the aircraft at a first time, wherein the second set of flight data includes a second position of the aircraft at a second time after the first time, and wherein generating the second GUI comprises updating the first GUI to correspond to a perspective of the celestial bodies from the second position of the aircraft at the second time.

15. The method of claim 12, wherein generating the first GUI comprises retrieving the first GUI from a database onboard the aircraft, and wherein generating the second GUI comprises retrieving the second GUI from the database.

16. The method of claim 12, wherein generating the first GUI comprises generating the first GUI based on the images and/or videos of celestial bodies stored on a database onboard the aircraft, and wherein generating the second GUI comprises generating the second GUI based on the images and/or videos of celestial bodies stored on the database.

17. The method of claim 12, further comprising:
receiving a user input selecting an event from the group including a rocket launch, a sunrise, a sunset, a solar eclipse, or a lunar eclipse;
generating, in a third time period after the second time period, a third GUI including one or more images and/or videos of the selected event; and
transmitting, in the third time period, the third GUI to a third display device in the aircraft.

18. The method of claim 12, further comprising:
receiving tracked eye movement of a passenger from a camera onboard the aircraft;
generating, in a third time period after the second time period, a third GUI based on the received tracked eye movement, the third time period, and a third position of a third display device in the aircraft, wherein the third GUI includes one or more images and/or videos of celestial bodies arranged and/or modified in a different manner than the first GUI and the second GUI; and
transmitting, in the third time period, the third GUI to the third display device.

19. The method of claim 12, further comprising:
receiving tracked body movement of a passenger from a camera onboard the aircraft;
generating, in a third time period after the second time period, a third GUI based on the received tracked body movement, the third time period, and a third position of a third display device in the aircraft, wherein the third GUI includes one or more images and/or videos of celestial bodies arranged and/or modified in a different manner than the first GUI and the second GUI; and
transmitting, in the third time period, the third GUI to the third display device.

20. A non-transitory computer-readable medium onboard an aircraft and having instructions configured to cause one or more processors to perform a method, the method comprising:
obtaining a first set of flight data from the aircraft;
generating, in a first time period, a first graphical user interface (GUI) including one or more images and/or videos of celestial bodies arranged and/or modified based on the obtained first set of flight data, the first time period, and a first position of a first display device in the aircraft;
transmitting, in the first time period, the first GUI to the first display device;
obtaining a second set of flight data from the aircraft;
generating, in a second time period after the first time period, a second GUI based on the obtained second set of flight data, the second time period, and a second position of a second display device in the aircraft, wherein the second GUI includes one or more images and/or videos of celestial bodies arranged and/or modified in a different manner than the first GUI; and
transmitting, in the second time period, the second GUI to the second display device.
